(19) United States
(12) Patent Application Publication
(10) Pub. No.: US 2005/0047396 A1
(43) Pub. Date: Mar. 3, 2005

(54) System and method for selecting the size of dynamic voice jitter buffer for use in a packet switched communications system

(76) Inventors: David P. Helm, Carol Stream, IL (US); Svend Frandsen, Praesto (DK)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/651,520

(22) Filed: Aug. 29, 2003

(51) Int. Cl. H04L 12/66

(52) U.S. Cl. 370/352; 370/516

(57) ABSTRACT

A packet switched communications system (100) for use with a dynamic voice jitter buffer (203) and voice over Internet protocol (VoIP) packets includes a source (101) transmitting at least one VoIP packet, one or more routers (105, 107, 109) for routing the VoIP packets and a destination (111) for receiving the at least one VoIP packet. The VoIP packet operates to convey congestion information regarding the packet switched communications system (100) to at least one buffer located at the destination to dynamically control the capacity of the jitter buffer located at the destination to provide VoIP communication with no jitter and minimal delay.

### TECHNICAL FIELD

This invention relates in general to voice over Internet protocol (VoiP) networks and more particularly to the reduction of non-periodic packet reception over a VoIP network.

### BACKGROUND

Modern two-way radio systems used for public safety and military applications are packet based systems that use Internet protocol (IP) routers to interconnect a plurality of mobile switching offices and base sites. An example of such a system is the Motorola X-ZONE radio system which interconnects networked base stations using the Internet and voice over IP technology.

Those skilled in the art will recognize that an IP packet is typically comprised of at least 14 fields. One of the fields used in the IP packet is a time to live (TTL) field. When a packet is sent from a computer, it is sent with a certain TTL value. As is well known in the art, each time a packet crosses a router this value is decreased by one until the value is 0, at which point the packet is dropped. This technique ensures that bandwidth is not used up by lost packets forever circling the network. Because the size of this field is 8 bits, the maximum number of hops that can be set is 255.

Although packet switched networks have numerous advantages over those that are circuit switched, one disadvantage of using the packet system is the delay and voice jitter that is introduced as a packet travels through the IP network on its way to an endpoint. As a packet propagates through various network routers on its way to a destination, small amounts of delay are introduced at each router. As this delay continues to accrue, it results in the non-periodic reception of the packet at the destination point. This phenomenon is generally known as “jitter”. As known to those skilled in the art, these are common problems when using Internet telephony or any voice based packet system since the minimal delay is required from the sourcing point to end point if real time communication is to occur. Since packets are typically generated by the sourcing device in periodic 60 mS intervals, they need to be received also at the same periodic rate of 60 mS to prevent discontinuity and choppiness in the audio stream. The vocoder receiving information in such a non-periodic fashion will remain silent or can have other undesirable anomalies such as distortion or squealing.

One way to mitigate the non-periodic nature of voice over IP (VoIP) packet traffic being received in this fashion is through the use of a voice jitter buffer. The voice jitter buffer is a memory that is of predetermined size. The voice jitter buffer works to store or buffer incoming VoIP packets so that the non-periodic reception of incoming packets can be minimized. Packets are stored for some predetermined time so to introduce a smoothing effect to minimize the time delay between packets. As the delay is minimized, the gaps between packets can be reduced or eliminated so that a periodic flow of packet reception can occur. The implementation of one or more jitter buffers offers an advantage in that it can provide a means to supply an even better continuous flow of packet information. Packets can be stored and released from the voice jitter buffer when a periodic flow of packet information can be produced.

The disadvantage of using a voice jitter buffer is that it introduces unacceptable delays in the receipt of these audio communications. Often in radio communications, it is necessary that all information be conveyed in a manner that is as close to real time as possible. The larger the jitter buffer, the longer delay that will be introduced since packets will remain queued in the buffer for a longer period of time. Thus, it is necessary to keep the voice jitter buffer as small as possible in order to mitigate this delay. This is particularly important in a public safety/mission critical environment where any miscommunication due to delay could be life threatening.

In order to overcome lengthy delays of the buffered packet data, a dynamic jitter buffer is sometimes used to adjust the size of the storage buffer producing only a minimal amounts of audio lag and delay. A dynamic jitter buffer operates by determining the amount of delay needed from the previously received packet and then adjusts the buffer size based upon the minimal amount of delay that is needed to provide a consistent flow of data packets. Thus, the dynamic jitter buffer is filled to a static amount at the beginning of a VoIP call, when the buffer is empty. When the buffer is underrun i.e. it becomes empty it is then re-filled a higher capacity. This is the type of adjustment technique that is typically used with VoIP traffic today although this approach only works to prevent loss of information due to jitter after the problem has occurred. Once the VoIP system employing a dynamic jitter buffer has recognized that there has been some delay beyond a predetermined limit only then will a larger buffer be created to compensate for this delay. As noted above, in mission critical situations, any loss of voice information is unacceptable so methods must be implemented to ensure that no information is lost. Present methods of dynamically adjusting voice jitter buffer size are unacceptable since a correction is made only after a problem has occurred.

Thus, the need exists for a system and method that can dynamically adjust the size of a jitter buffer in a VoIP network upon initial voice stream reception so as to prevent loss of information or unnecessary delay. The new solution should be capable of being implemented with existing technology so that existing VoIP packet switched communications networks need not be reconfigured in order to benefit from these advancements.

### SUMMARY OF THE INVENTION

Briefly, according to the invention, there is provided a system and method for use with a dynamic voice jitter buffer located at an end device that utilizes common information conveyed through IP packets in order to adjust jitter buffer size. If an IP network is either heavily loaded with traffic, has one or more low-speed links, or whose architecture includes voice traffic traveling over a long distance where the connection between routers has some degradation in speed, the present invention provides a means by which an IP packet can be used to convey congestion information to a voice jitter buffer at an end destination. The end destination can then use this information from a packet field in order to set a minimal static jitter buffer size in order to prevent under run of incoming voice data. More specifically, either a time-to-live (TTL) field or other special fields in the IP packet header can be used to set a parameter value which is read at an end point destination device. This value is then mapped at the destination in order to set the static size of the jitter buffer and prevent and/or mitigate the non-periodic receipt of VoIP packets resulting in choppy and discontinuous audio received at an end destination.

### BRIEF DESCRIPTION OF THE DRAWINGS

The features of the present invention, which are believed to be novel, are set forth with particularly in the appended claims. The invention, together with further objects and advantages thereof, may best be understood by reference to the following description, taken in conjunction with the accompanying drawings, in the several figures of which like reference numerals identify like elements, and in which:

FIG. 1 is a block diagram illustrating the configuration of an IP network having a plurality of routers.

FIG. 2 is a block diagram showing operation of a destination for receiving a VoIP packet.

FIG. 3 is a flow chart diagram illustrating operation of a voice over IP packet source station with setting of a time-to-live (TTL) packet field.

FIG. 4 is a flow chart diagram illustrating operation of a router used in a VoIP network wherein the TTL field is decremented as it passes though each router.

FIG. 5 is a flow chart diagram illustrating operation of a voice over IP packet destination station wherein mapping is used to selected jitter buffer size from the TTL field.

FIG. 6 is a flow chart diagram illustrating an alternative embodiment of the invention wherein the router determines link speed and sets a congestion bit in an VoIP packet header.

FIG. 7 is a flow chart diagram illustrating operation of the congestion bit at the destination wherein the capacity of the jitter buffer can be adjusted based on the presence or absence of a congestion bit.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

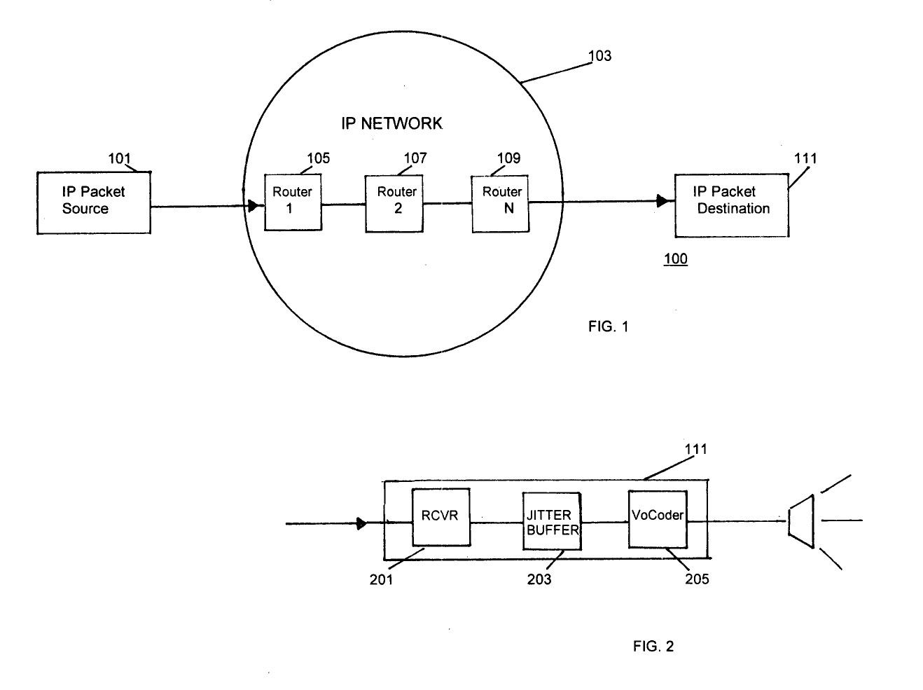

As seen in FIG. 1, a packet switched communications system 100 for transmitting and receiving voice over Internet protocol (VoIP) packets includes a VoIP packet source 101. As will be recognized by those skilled in the art, the VoIP packet source may transmit both voice and data packets which are routed to a final destination through one or more routers located within an IP network 103. Among other things, the IP network 103 includes a plurality of routers that are used to direct a packet from source 101 to a destination. The routers work to read address fields with a packet to route the packet along a predetermined transmission path. FIG. 1 illustrates routers (1) 105, router (2) 107 and router (N) 109 acting to provide a pathway for a packet to VoIP packet destination 111. As seen in FIG. 2, the destination 111 includes a receiver 201, jitter buffer 203 and vocoder 205 which is used to decode incoming VoIP packets in order to provide an audible message transmitted within the packet.

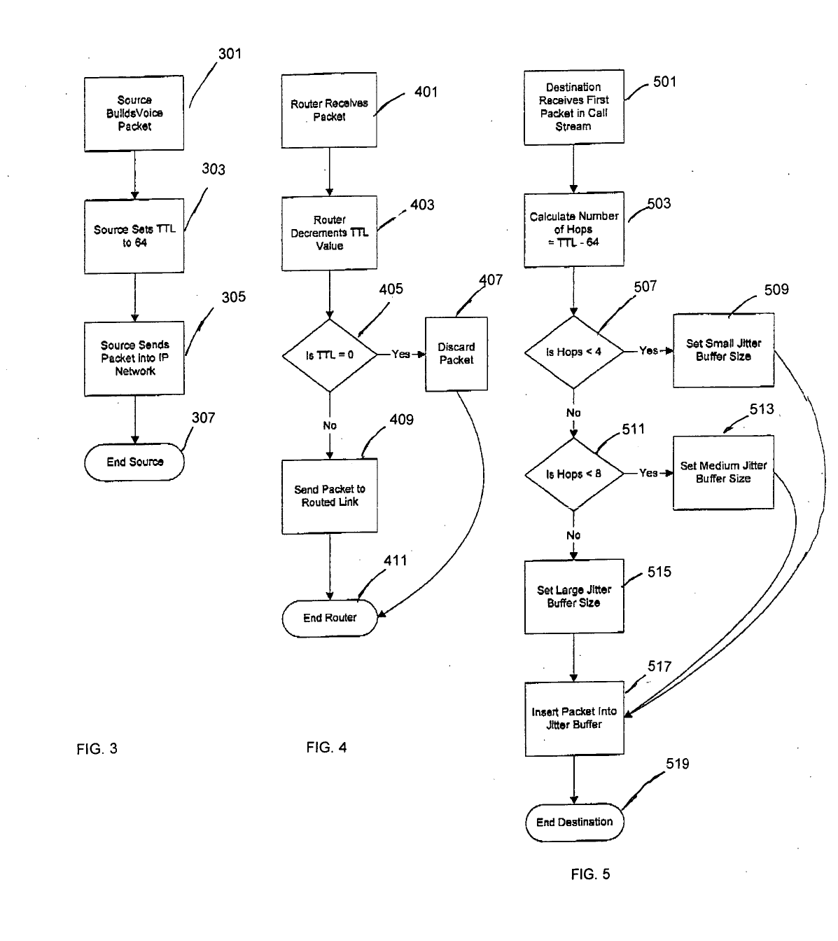

According to the preferred embodiment of the invention, FIGS. 3 through 5 illustrate flow chart diagrams where a time-to-live field (TTL) within a packet may be used to control the size of a jitter buffer at the packet's destination. Specifically, FIG. 3 shows the steps for setting the TTL field to a predetermined number wherein the source builds a VoIP packet 301 and the TTL field within the packet is set 303 to a predetermined number such as 64. The source then sends or transmits 305 the packet on to the network which ends 307 the requirements of the source until transmission of a following packet. In FIG. 4, a router receives 401 the VoIP packet from the source and decrements the TTL value by at least one count as it traverses the router. In order that old packets may be discarded without continually moving about the packet communications system, if the TTL value is equal to zero 405, the packet may be discarded 407 since it has not made it to its destination within a maximum number of passes though a router in the system. However, if the TTL field has not been decremented to zero, it is routed through the router toward its destination. As is well known in the art, the router uses an address field within the packet where it is forwarded 409 along the next pathway or link towards its destination. This then ends 411 the router's operation until receipt of the next VoIP packet voice stream where the jitter buffer may be reset to a different capacity. It should be further recognized that, although specific values have been used in the TTL field by way of example, any value may be selected so as to provide optimal system operation.

FIG. 5 illustrates the steps whereby an initial or first VoIP packet reaches its destination. Since the TTL value decrements on its way to the destination, a final TTL value may be used to determine packet propagation through the packet switched communications system. The destination will then interpret 501 the TTL field and calculate 503 the number of routers that the packet has traversed on its way to the destination. For example, since the TTL field was initially set to 64 at the source, the difference between 64 and the current TTL field will reveal the number of routers that the VoIP packet jumped or “hopped” before reaching its destination. If the number of hops is less than some predetermined number such as 4, the size of the jitter buffer will be set to a small buffer size. Subsequently, the packet will then be forwarded 517 to the jitter buffer. Similarly, if the number of hops is less than a second predetermined number such as 8, then a larger buffer will be needed to mitigate the greater delay. A medium sized buffer will be set 513 whereby the packet is then forwarded 517 to the jitter buffer. Finally, if it is determined that the number packets has traversed even a greater number of routers and the number of hops is greater than the second predetermined amount, then an even larger jitter buffer size will be set 515.

In the example depicted in FIG. 5, this value is 8 and if more than 8 hops are calculated, the largest of the jitter buffer sizes might be selected. As with the other packets, the packet is subsequently forwarded 517 to the jitter buffer where it is queued for use by a vocoder. This ends 519 the operation of this alternative embodiment wherein the capacity of the jitter buffer is selected based on the number of router hops i.e. distance from the packet's originating location. These steps may be reinitiated after the expiration of some predetermined time or until reception of a new VoIP packet voice stream. At that time it may become necessary to reduce or increase the size of the jitter buffer due to delay or congestion of transmission links and/or routers on the communications system.

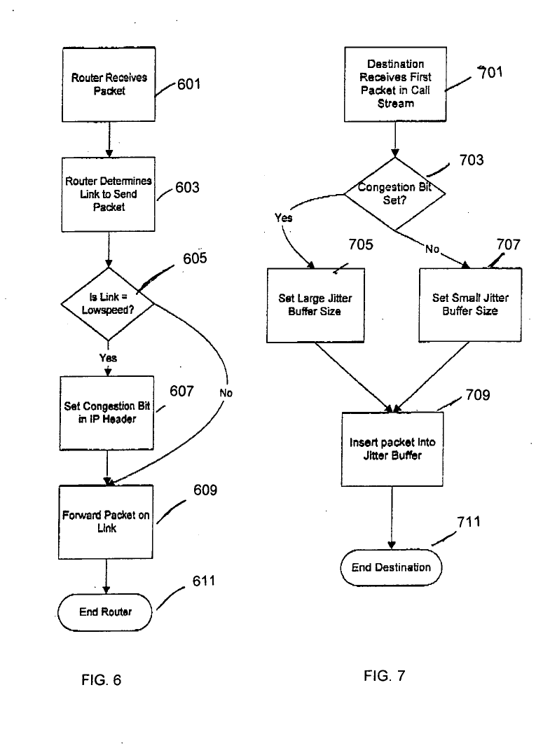

In an alternative embodiment of the invention a second method may be used to set the size of the jitter buffer at the destination based upon the setting of a predetermined field within the VoIP packet. FIG. 6 illustrates the steps used in the router where a router receives 601 a packet and the router determined 603 the link speed of the destination link. A router or other device determines the speed 605 of the destination communications link upon which the VoiP packet will be sent. As discussed herein, either link speed or link congestion is then used to set the congestion bit in the packet field. As known in the art, link congestion is calculated by dividing the number of bits sent per second by link speed by the speed available at the destination

If the speed of the communications link is above some predetermined threshold, then the packet is forwarded 609 towards its destination. Alternatively if the congestion of the link if calculated to be below a predetermined threshold, then the packet is forwarded 609 toward its destination. However, if the link speed is below the threshold level due to a lesser than optimum destination link speed, or the calculated congestion is higher than the threshold level due to a congested link, a congestion field and/or bit is set 607 with the VoIP packet. The bit may be set to a specific numeric value called the congestion value based up on the link speed or congestion determined by the router. Once the router forward the VoIP packet towards its destination, this ends 611 the necessity of the router to set this congestion field until a subsequently packet is received. Those skilled in the art will recognize that although the destination link speed is used in this example, the link speed of the immediately preceding router might be known as well. Thus, the speed over the immediately preceding link might also be sued to set the congestion field.

FIG. 7 illustrates the steps used in this alternative method wherein the destination receives the first VoIP packet in the call stream. Based on this information, the destination can then determine 703 if the congestion field has been set. If a congestion bit has been set, this indicates that a large jitter buffer size is required at the destination which is then selected 705. The packet is then subsequently forwarded 709 to the jitter buffer. However, if the congestion bit is not detected, this indicates that there is a lesser delay then some preselected level which does not require the larger jitter buffer size. In this case, a jitter buffer smaller than the larger size might be set 707 whereby the packet can then be forwarded 709 to this jitter buffer. Once the jitter buffer size is set by the first packet in the call stream, this ends 711 the operation to set the jitter buffer size at the destination. As will be recognized by those skilled in the art, in other alternative embodiments, the congestion field in the packet header may be set to differing values. Thus, the congestion bit may be set to many differing congestion values based on the packet switched communications networks over packet traffic congestion and delay. For example, a congestion field or bit may be set to a first predetermined value if there is no congestion or to a second predetermined value if there is moderate congestion. If the system is experiencing heavy traffic congestion it might be set to a third predetermined value. This enables the jitter buffer at the destination to be set to any appropriate size to provide the most consistent flow of packet information to the listener. This enables a smooth, consistent and relative periodic flow of audio at the destination to reduce the effect of choppiness and voice jitter in the audio produced by a vocoder.

In summary, the present invention may operate using one of two embodiments in order to set a static size of the jitter buffer. This enables the most consistent and periodic reception of VoIP packets while introducing the least amount of delay due to jitter buffer size. These embodiments include: 1) setting all packets to known TTL value, while the end point destination examines the TTL value of the first received packet and selects the static value of the jitter buffer; or 2) setting a congestion field or bit in a VoIP packet if the packet traverses a low speed or congested link. The destination then uses the congestion bit in the first received packet, to determine the static value size of the jitter buffer.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A packet switched communications system having a dynamic voice jitter buffer for use with voice over Internet protocol (VoIP) packets comprising:
a source transmitting at least one VoIP packet;
at least one router for routing the VoIP packet to a specified destination;
a destination for receiving the at least one VoIP packet; and
wherein the VoIP packet operates to convey congestion information regarding the packet switched communications system to at least one buffer located at the destination.

2. A packet switched communications system as in claim 1, wherein the VoIP packet conveys congestion information comprising the steps of:
setting the time-to-live (TTL) field in the VoIP packet to a predetermined value;
decrementing the TTL value by one count as it traverses each respective router in the packet switched communications system;
calculating the number of routers the VoIP packet has passed through based on a final TTL value determined at the destination; and
adjusting the capacity of the at least one buffer at the destination based on the final TTL value in order to mitigate non-periodic receipt of incoming VoIP packets at the destination.

3. A packet switched communications system as in claim 2, further including the step of:
selecting a first, second or third capacity of the at least one buffer based upon the final TTL value.

4. A packet switched communications system as in claim 1, wherein the VoIP packet conveys congestion information comprising the steps of:
determining the speed upon which the VoIP packet has been received at the at least one router;
setting at least one field in the VoIP packet to indicate if the packet has traversed at least one previous router below a predetermined speed; and
adjusting the capacity of at least one buffer at the destination based upon recognition of the at least one field in order to mitigate non-periodic receipt of incoming VoIP packets at the destination.

5. A packet switched communications system as in claim 4, further including the step of:
setting the least one field within the VoIP packet with a congestion value based upon the speed of the originating link.

6. A packet switch communications systems claim 4, further including the step of:
setting the least one field within the VoIP packet with a congestion value based upon the speed of the destination link.

7. A packet switched communications system as in claim 1, further including the step of:
selecting a first, second or third capacity of the at least one congestion value.

8. A packet switched communications system as in claim 1, wherein the VoIP packet conveys congestion information comprising the steps of:
determining at the at least one router if a received packet has encountered at least one congested router;
setting at least one field in the VoIP packet indicating if the communications speed of a destination link is below a predetermined threshold; and
adjusting the capacity of at least one buffer at the destination based upon recognition of the at least one field in order to mitigate non-periodic receipt of incoming VoIP packets at the destination.

9. A packet switched communications system as in claim 8, further comprising the step of:
selecting a first, second or third capacity of the at least one buffer based upon a value set within the at least one field.

10. A method for adjusting the size of a jitter buffer for use in a voice over Internet protocol (VoIP) packet switched communications system comprising the steps of:
adjusting the time-to-live (TTL) field in a VoIP packet to a predetermined value at a source;
decrementing the TTL field by at least one count each time the VoIP packet traverse a router in the VoIP packet system;
reading the TTL field at a destination; and
adjusting the size of a jitter buffer based upon the TTL value in order to mitigate the effect of receipt of non-period VoIP packets at the destination.

11. A method for adjusting the size of a jitter buffer, as in claim 10:
wherein the jitter buffer is located at the destination.

12. A method for adjusting the size of a jitter buffer, as in claim 10 further includes the steps of:
comparing the predetermined value of the TTL field with the value read at the destination to produce a compared value; and
mapping the compared value to a predetermined jitter buffer capacity to provide a substantially continuous flow of VoIP packets from jitter buffer.

13. A method for adjusting the size of a jitter buffer as in claim 12, further comprising the step of:
setting the capacity of the jitter buffer to either a first, second or third predetermined capacity based upon the compared value.

14. A method for adjusting the size of a jitter buffer for use with a packet network transmitting voice over Internet protocol (VoIP) packets based upon transmission path delay comprising the steps of:
determining the amount of transmission delay through a transmission path that a VoIP packet has encountered upon receipt by at least one router in the packet network;
setting a field within the VoIP packet when the transmission rate for a link used for the VoiP is below a predetermined threshold;
recognizing the field at a destination of the VoIP packet; and
adjusting the size of a jitter buffer based upon recognition of the field in order to mitigate the effect of receipt of non-periodic VoiP packets at the destination.

15. A method for adjusting the size of a jitter buffer as in claim 14, wherein the jitter buffer is located at the destination.

16. A method for adjusting the size of a jitter buffer as in claim 14, further including the steps of:
setting the field using a numeric value based upon the amount of transmission path delay; and
mapping the numeric value into a minimal jitter buffer size required for that amount of delay.

17. A method for adjusting the size of a jitter buffer as in claim 14, further comprising the step of:
adjusting the size of the jitter buffer to either a first, second or third capacity based upon the numeric value set within the field.

18. A method for adjusting the size of a jitter buffer for use with a packet network transmitting voice over Internet protocol (VoIP) packets based upon transmission path delay comprising the steps of:
determining the amount of transmission delay through a transmission path that a VoIP packet has encountered upon receipt by at least one router in the packet network;
setting a field within the VoIP packet when the congestion of the link exceeds a predetermined threshold;
recognizing the field at a destination of the VoIP packet; and
adjusting the size of a jitter buffer based upon recognition of the field in order to mitigate the effect of receipt of non-periodic VoiP packets at the destination.

19. A method for adjusting the size of a jitter buffer as in claim 18, wherein the jitter buffer is located at the destination.

20. A method for adjusting the size of a jitter buffer as in claim 18, further including the steps of:
setting the field using a numeric value based upon the link congestion; and
mapping the numeric value into a minimal jitter buffer size required for that amount of delay.

21. A method for adjusting the size of a jitter buffer as in claim 18, further comprising the step of:
adjusting the size of the jitter buffer to either a first, second or third capacity based upon the numeric value set within the field.
